(19) United States
(12) Patent Application Publication
(10) Pub. No.: US 2019/0239991 A1
(43) Pub. Date: Aug. 8, 2019

(54) WATER TOOTHBRUSH

(71) Applicant: WATERLOO Co., Gyeonggi-do (KR)

(72) Inventor: Young Chai Choi, Gyeonggi-do (KR)

(21) Appl. No.: 15/888,392

(22) Filed: Feb. 5, 2018

(51) Int. Cl. A61C 17/02; A46B 11/00; A46B 11/06

(52) U.S. Cl. CPC A61C 17/0202; A61C 17/0214; A46B 2200/108; A46B 11/0079; A46B 11/063; A46B 11/0006

(57) ABSTRACT

A water toothbrush according to the present invention includes a body housing having an inner hole formed along its central axis in its longitudinal direction; a water supply pipe combined with a water supply inserted into one side of the body housing; a drawing pipe whose one side is inserted into the other side of the body housing; a toothbrush body, connecting to the other side of the drawing pipe, which has a head planted with bristles, an emitting hole formed on the surface of the head planted with bristles, and an emitting flow channel for linking the drawing pipe and the emitting hole; and a flow channel assembly installed in the inner hole of the body housing and connecting the other side of the water supply pipe with one side of the drawing pipe, for guiding cleaning water supplied by the water supply pipe into the drawing pipe.

### DESCRIPTION OF THE INVENTION

### Technical Field

The present invention relates to a water toothbrush configured to emit cleaning water between the bristles of a toothbrush, and more specifically to, a water toothbrush where a water supply pipe for supplying cleaning water and a toothbrush body planted with bristled are easily detachable and which is simply managed and repaired.

### Background Art

As widely known, a toothbrush, having a toothbrush body gripped by the hand and bristles fixed perpendicularly on the head portion of the front end of the toothbrush body to brush out all food residues inserted between and attached to teeth, is a tool to keep teeth clean and prevent various diseases relating to teeth.

However, there are cases where the food residues between teeth are not removed depending on how people brush their teeth with a tooth brush. In this case, over a period of time, plaque is formed on teeth, thereby leading to gum disease such as periodontal disease and leading to tooth decay.

Furthermore, people have difficulty in cleaning the inner side teeth using only a tooth brush, although they try to brush their teeth in the right way. Cleaning teeth with only a toothbrush can cause inconvenience to people and is not enough because the inner side teeth is closed to the flesh of the inside of the cheek. As a result, it is well known that the inner side teeth are more easily decayed than the front teeth.

In particular, while teeth and gums closely adhere to each other and there is almost no space or a very narrow space between teeth, the bristles of a toothbrush have a certain diameter. As a result, bristles are not enough to clean even the space between teeth and gums, and between teeth, and food residues are accumulated in such space and form plaque thereby resulting in tooth decay.

In general, it is natural to rinse the inside of the mouth with water contained in a cup so as to wash away the food residues removed by a toothbrush. However, this can be bothersome, and rinsing teeth with water might not be carried out properly. Additionally, the cup is used by family members. This is inherently related to the issue of insanitation.

Meanwhile, as a means to solve the above described problems, in Korean Official Report for Registration Utility Model No. 20-0229913, provided is a toothbrush emitting cleaning water between bristles thereof, which has a plurality of holes for emitting formed on the head portion of the toothbrush, and has a water passage, formed on the body of the toothbrush, connecting with a water supply hose, such that cleaning water may be emitted between the bristles of the toothbrush, and that teeth, gums and the oral cavity may be cleaned in a more comfortable way, at the time when the user brushes their teeth.

However, the above described invention has a problem in that it is difficult to manufacture such a toothbrush because it has a structure in which the head part of the tooth brush, emitting holes inside of the toothbrush body and the water channel for linking the head part and the emitting holes are simultaneously formed by manes of injection molding. Furthermore, the head of the toothbrush and the body of the toothbrush are integrally configured. This means when the bristles of the toothbrush are worn out after a certain period of time, the toothbrush itself should be replaced with a new one, thereby incurring a large amount of costs. In addition, the water supply hose is connected with the body of the tooth brush all the time, thereby causing inconvenience when cleaning water does not need to be emitted. Furthermore, it is difficult to wash out the water channel for cleaning water and this is related to insanitation.

### PRIOR ART DOCUMENT

### Patent Document

(Patent Document 0001) Korean Patent No. 20-0229913 Y1

### DISCLOSURE

### Technical Problem

The present invention is devised to solve the above-described problems and is directed to providing a water toothbrush which is capable of emitting high-pressure cleaning water between bristles, enables a toothbrush body and a water supply pipe to be simply detached without a water leak, and enables each part to be separated and detached, so as to provide a tooth brush the user may readily use wash, manage and repair.

### Technical Solution

As a means to solve the problems above described, a water toothbrush according to the present invention includes a body housing extended in one direction and having an inner hole formed along its central axis in its longitudinal direction; a water supply pipe whose one side in its longitudinal direction is combined with a water supply hose and whose other side in its longitudinal direction is inserted into the one side of the body housing in the longitudinal direction of the body housing and which has a first sliding bump protruding on the part, out of its outer circumferential surface, inserted into the body housing; a drawing pipe whose one side in its longitudinal direction is inserted into the other side of the body housing in the longitudinal direction of the body housing and which has a second sliding bump protruding on the part, out of its outer circumferential surface, inserted into the body housing; a toothbrush body, connecting to the other side of the drawing pipe in the longitudinal direction of the drawing pipe, which has a head planted with bristles, an emitting hole formed on the surface, out of the head, where the bristles are planted, and an emitting flow channel for linking the drawing pipe and the emitting hole; and a flow channel assembly fixedly installed in the inner hole of the body housing and connecting the other side of the water supply pipe in the longitudinal direction of the water supply pipe with one side of the drawing pipe in the longitudinal direction of the drawing pipe, for guiding cleaning water supplied by the water supply pipe into the drawing pipe, wherein the body housing has respectively a first sliding groove and a second sliding groove which are formed in both sides of the inner wall of the body housing in the longitudinal direction thereof, inclinedly arranged in a direction crossing to the circumferential direction of the body housing, and wherein the first sliding bump and the second sliding bump are configured to be mounted respectively into the first sliding groove and the second sliding groove when the other side of the water supply pipe in the longitudinal direction of the water supply pipe and one side of the drawing pipe in the longitudinal direction of the drawing pipe are inserted into the body housing, such that the water supply pipe and the drawing pipe may be combined with and detached from the flow channel assembly according to the direction of their rotation.

The part, out of the outside wall surfaces of the first sliding groove and the second sliding groove, corresponding to the first sliding bump or the second sliding bump, when the water supply and the drawing pipe are inserted, is formed low so as not to interfere with the first sliding bump or the second sliding bump.

The part, out of the inside wall surfaces of the first sliding groove and the second sliding, corresponding to the first sliding bump or the second sliding bump, when the water supply and the drawing pipe are inserted, is formed high so as to catch the first sliding bump or the second sliding bump.

When the water supply pipe and the drawing pipe are inserted into the body housing to a preset depth, a protruding sill over which the first sliding bump and the second sliding bump go is formed on the outside wall surface of the first sliding groove and on the outside wall surface of the second sliding groove.

The flow channel assembly,

consists of a first joining pipe where the water supply pipe is fitted and inserted on one side of the first joining pipe in the longitudinal direction thereof and where a first inserting groove is formed on the other end of the first joining pipe in the longitudinal direction thereof, a first connecting pipe where a first inserting bump press-fitted into the first inserting groove is formed to protrude on one end of the first connecting pipe in the longitudinal direction thereof and where a first nipple is provided on the other side of the first connecting pipe in the longitudinal direction thereof, a second joining pipe where a second inserting groove is formed on one end of the second joining pipe in the longitudinal direction thereof and where the drawing pipe is fitted and inserted into the other side of the second joining pipe in the longitudinal direction thereof, a second connecting pipe where a second nipple is provided on one side of the second connecting pipe in the longitudinal direction thereof and where a second inserting bump press-fitted into the second inserting groove is formed to protrude on the other end of the second connecting pipe in its longitudinal, and a tube pipe connecting the first nipple and the second nipple.

A first joining flange is formed on the outer circumferential surface of the other side of the first joining pipe in the longitudinal direction thereof, and a first connecting flange is formed on the outer circumferential surface of one side of the first connecting pipe in the longitudinal direction thereof, a second joining flange is formed on the outer circumferential surface of one side of the second joining pipe in the longitudinal direction thereof, and a second connecting flange is formed on the outer circumferential surface of the other side of the second connecting pipe in the longitudinal direction of the second connecting pipe, and

a first press-fitting groove into which the first joining flange and the first connecting flange are press-fitted, and a second press-fitting groove, into which the second joining flange and the second connecting flange are press-fitted, are formed on the inner wall of the body housing.

A first O-ring is provided on the surface where the first joining pipe and the first connecting pipe are touched to each other, and a second O-ring is provided on the surface where the second joining pipe and the second connecting pipe are touched to each other,

when the first joining flange and the first connecting flange are press-fitted into the first press-fitting groove, the first joining pipe and the first connecting pipe are pressed in the direction where they become close to each other, such that the first O-ring is compressed, and

when the second joining flange and the second connecting flange are press-fitted into the second press-fitting groove, the second joining pipe and the second connecting pipe are pressed in the direction where they become close to each other, such that the second O-ring is compressed.

### Advantageous Effects

With a water toothbrush according to the present invention, high-pressure cleaning water emitted between bristles may clean teeth better, a toothbrush body and a water supply pipe are simply detachable without a water leak, and each part may be detached and replaced, such that a flow channel for cleaning water is readily washed out and each part is readily managed and repaired.

### DESCRIPTION OF DRAWINGS

FIGS. 1 to 3 are a perspective view, an exploded perspective view and a longitudinal cross-sectional view illustrating a water toothbrush according to the present invention.

FIGS. 4 and 5 are an exploded cross-sectional view illustrating a flow channel assembly and a cross-sectional view illustrating an installed flow channel assembly included in a water toothbrush according to the present invention.

FIGS. 6 to 8 consecutively illustrate a process of combining a water supply pipe with a body housing.

FIG. 9 is a cross-sectional perspective view illustrating the inner structure of a body housing.

### EMBODIMENTS OF THE INVENTION

By reference to the accompanying drawings, the embodiments of a water toothbrush according to the present invention will be described in detail.

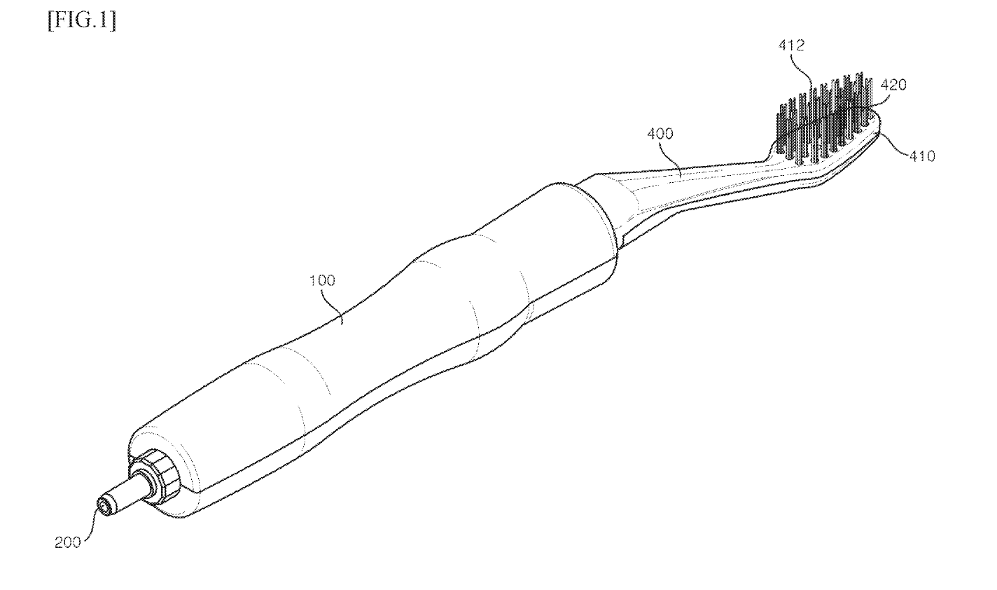

FIGS. 1 to 3 are a perspective view, an exploded perspective view and a longitudinal cross-sectional view illustrating a water toothbrush according to the present invention.

A water toothbrush according to the present invention, as a means to clean teeth better by using the cleaning water emitted between bristles 412, is characterized in that each part may be easily detached and replaced without a cleaning water leak, in addition to the function of emitting cleaning water performed by the water tooth brush.

That is, a water toothbrush according to the present invention includes a body housing 100 extended in one direction and having an inner hole formed along its central axis in its longitudinal direction, a water supply pipe 200 whose one side in its longitudinal direction (the left side in the embodiments) is combined with a water supply hose (invisible) and whose other side in its longitudinal direction (the right side in the embodiments) is inserted into the one side of the body housing 100 in the longitudinal direction of the body housing and which has a first sliding bump 210 protruding on the part, out of its outer circumferential surface, inserted into the body housing; a drawing pipe 300 whose one side in its longitudinal direction is inserted into the other side of the body housing 100 in the longitudinal direction of the body housing 100 and which has a second sliding bump 310 protruding on the part, out of its outer circumferential surface, inserted into the body housing 100, a toothbrush body 400 connecting to the other side of the drawing pipe 300 in the longitudinal direction of the drawing pipe 300, which has a head planted with bristles 412, has an emitting hole 420 formed on the surface, out of the head, where the bristles 412 are planted, and has an emitting flow channel 430 for linking the drawing pipe and the emitting hole 420, and a flow channel assembly 500 fixedly installed in the inner hole of the body housing 100 and connecting the other side of the water supply pipe 200 in the longitudinal direction of the water supply pipe 200 with one side of the drawing pipe 300 in the longitudinal direction of the drawing pipe 300, for guiding cleaning water supplied by the water supply pipe 200 into the drawing pipe 300.

Then, in case the water supply pipe 200 and the drawing pipe 300 are just fitted and combined to the body housing 100, the water supply pipe 200 and the drawing pipe 300 are highly likely to be detached from the body housing 100 when external force is exerted in the direction parallel to the longitudinal direction of the body housing 100. For instance, while the user brushes their teeth by gripping the body housing 100 by the hand, it is highly likely that the drawing pipe 300 falls off from the body housing 100, and in case the water supply hose combined with the water supply pipe 200 is pulled, it is highly likely that the water supply pipe 200 falls off from the body housing 100.

Naturally, to solve the problems described above, the method of screwing the water supply pipe 200 and the drawing pipe 300 into the body housing 100 may be suggested, but considering that the water supply pipe 200 and the drawing pipe 300 are rotated several times to screw the water supply pipe 200 and the drawing pipe 300 into the body housing 100, and then connected to a flow channel assembly 500 inside the body housing 100, it is difficult to assemble and disassemble them.

A water toothbrush according to the present invention, as a means to solve the problems described above, is characterized in that when the water supply pipe 200 and the drawing pipe 300 are inserted in a linear way at a certain level before the water supply pipe 200 and the drawing pipe 300 rotate at an angle of about 90 degrees, the water supply pipe 200 and the drawing pipe 300 are combined with the body housing 100, and then, even when external force is exerted in the direction parallel to the longitudinal direction of the body housing 100, the water supply pipe 200 and the drawing pipe 300 do not fall off from the body housing 100.

That is, the body housing 100 has respectively a first sliding groove 110 and a second sliding groove 120, which are formed in both sides of the inner wall of the body housing 100 in the longitudinal direction thereof, inclinedly arranged in a direction crossing to the circumferential direction of the body housing 100, and when the other side of the water supply pipe 200 in the longitudinal direction of the water supply pipe 200 and one side of the drawing pipe 300 in the longitudinal direction of the drawing pipe 300 are inserted inside the body housing 100, the first sliding bump 210 and the second sliding bump 310 are configured to be mounted respectively on the first sliding groove 110 and the second sliding groove 120. As described above, when the water supply pipe 200 and the drawing pipe 300 rotate in the state where the first sliding bump 210 and the second sliding bump 310 are mounted into the first sliding groove 110 and the second sliding groove 120 depending on the direction of their rotation, the water supply pipe 200 and the drawing pipe 300 move forwards or backward so as to be combined with and detached from the flow channel assembly 500.

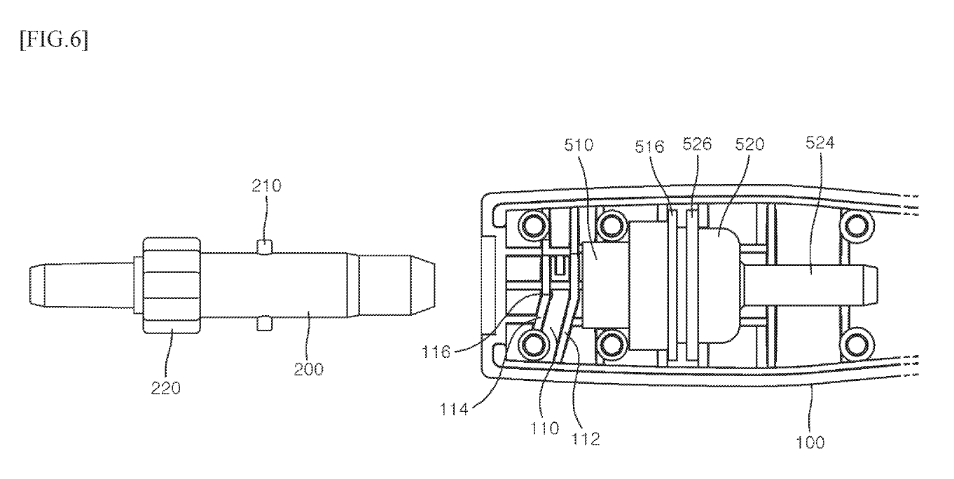

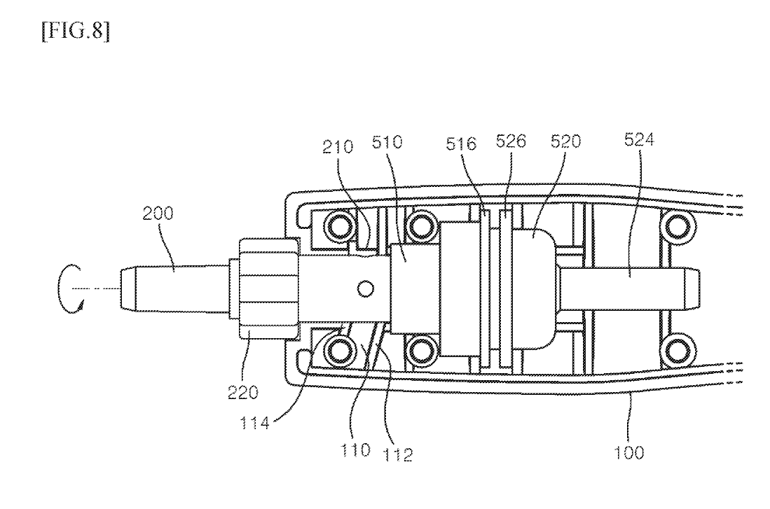

According to a water toothbrush of the present invention described above, when the water supply pipe 200 and the drawing pipe 300 combine with the body housing 100, the first sliding bump 210 and the second sliding bump 310 are respectively caught by the first sliding groove 110 and the second sliding groove 120 and as a result, the water supply pipe 200 and the drawing pipe 300 do not fall off from the body housing 100 even when external force is exerted to the water supply pipe 200 and the drawing pipe 300 in the longitudinal direction of the body housing 100. Furthermore, although the water supply pipe 200 and the drawing pipe 300 do not rotate several times, the water supply pipe 200 and the drawing pipe 300 safely combine with the body housing 100 and rapidly and simply are combined with and detached from the housing body 100. By reference to FIGS. 6 to 9, a process of combining the water supply pipe 200 and the drawing pipe 300 with body housing 100, as described above, will be described in detail.

The cleaning water provided to the water supply pipe 200 is delivered to the drawing pipe 300 through the flow channel assembly 500, passes through the emitting flow channel 430 and is emitted from the emitting hole 420. Then, the forming location and the number of the emitting hole 420 may vary in accordance with the part where the cleaning water is emitted. The cleaning water emitted from the emitting hole 420 cleans the user's teeth and the space between the teeth. The technical spirit described above, in which teeth and the space between teeth are cleaned by means of cleaning water emitted at high pressure, will not be described in detail, as it is substantially the same as that of traditional water emitting toothbrushes.

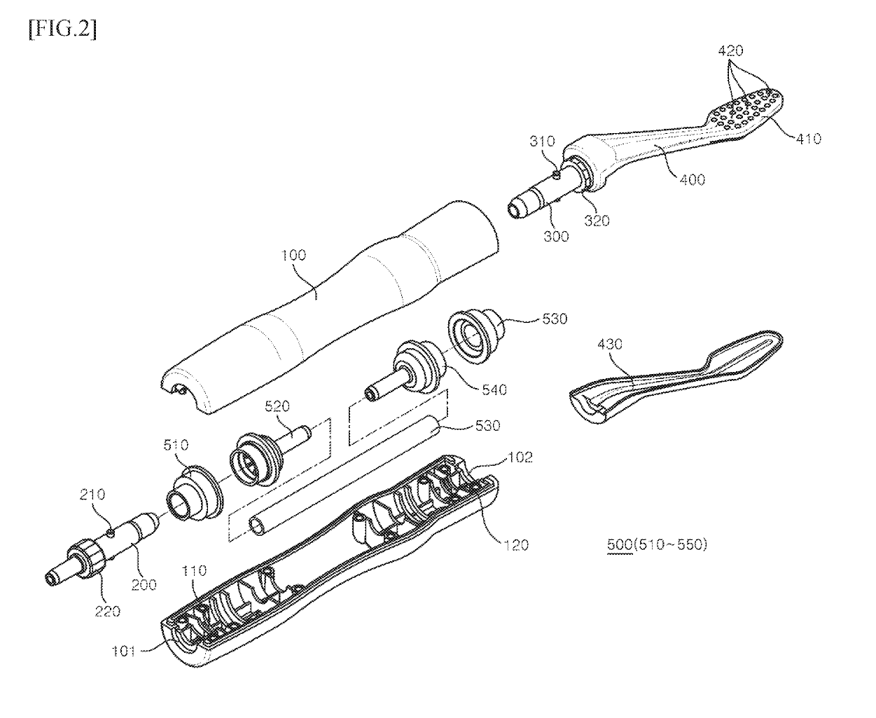

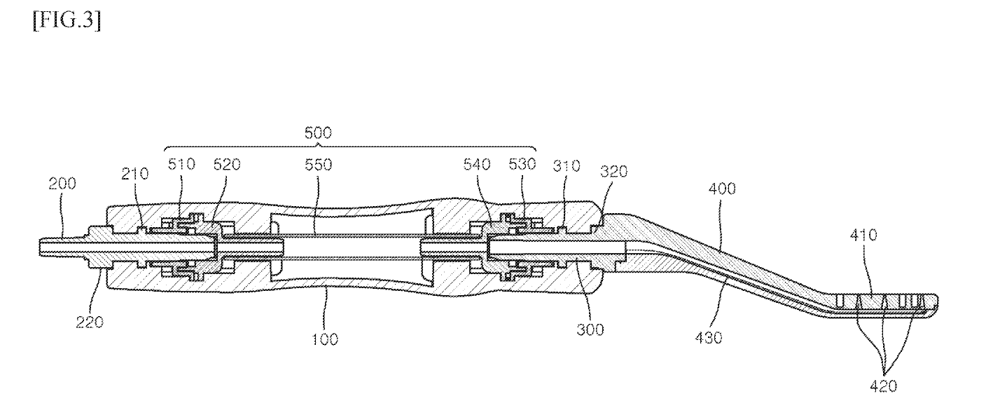

Furthermore, if the cleaning water provided to the water supply pipe 200 fills the inside space of the body housing 100 and then, the cleaning water is delivered to the drawing pipe 300, the pressure of the cleaning water becomes significantly low, and the cleaning water may leak from each part of the body housing 100 and may be contaminated. Accordingly, the cleaning water provided to the water supply pipe 200 is preferably delivered to the drawing pipe 300 through the separate flow channel assembly 500 as illustrated in FIGS. 2 to 3.

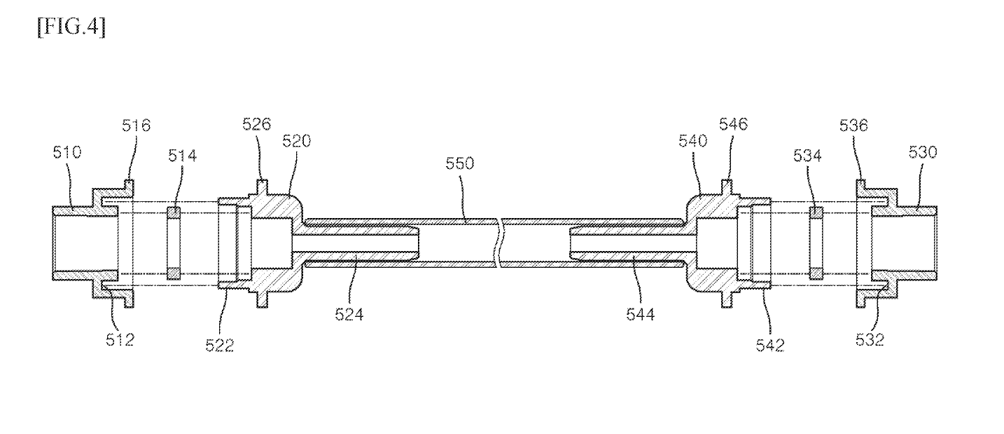

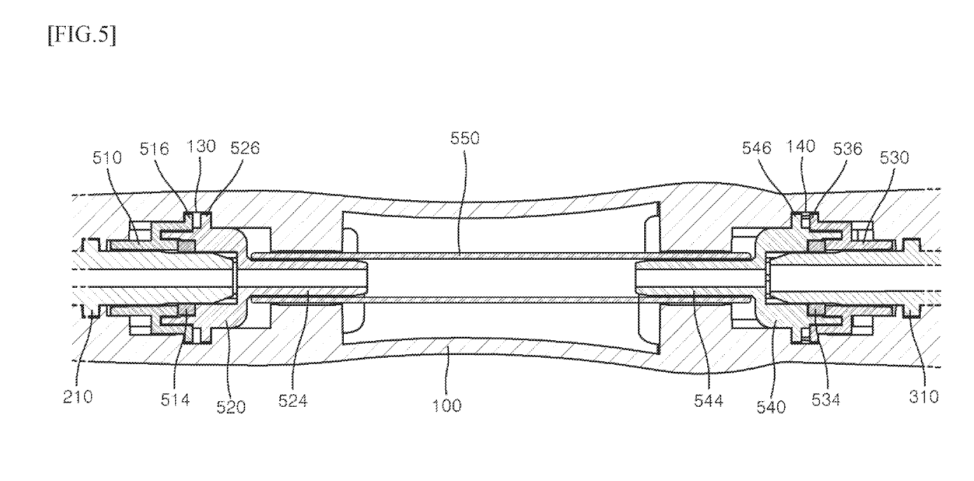

The flow channel assembly 500 is configured to safely combine the water supply pipe 200 and the drawing pipe 300 while minimizing the pressure drop of cleaning water. The inner structure and combining structure of the flow channel assembly 500 described above will be described in detail by reference to FIGS. 4 and 5.

Meanwhile, the water supply pipe 200 and the drawing pipe 300 are not inserted so deeply into the body housing 100, a first mounting step 101 and a second mounting step 102 are formed on both ends of the body housing 100 in the longitudinal direction thereof, and a first mounting block 220 and a second mounting block mounted 320 into the first mounting step 101 and the second mounting step 102 are respectively formed on the middle of the outer circumferential surfaces of the water supply pipe 200 and the drawing pipe 300. The first mounting block 220 and the second mounting block 320 are components serving as a stopper for blocking the water supply pipe 200 and the drawing pipe 300 from being inserted into the body housing 100 so deeply. Such a stopper will not be described in detail, as it is commercialized in various forms in the technical field to which the present invention pertains.

FIGS. 4 and 5 are an exploded cross-sectional view illustrating a flow channel assembly and a cross-sectional view illustrating an installed flow channel assembly included in a water toothbrush according to the present invention.

The flow channel assembly 500 for delivering the cleaning water, provided to the water supply pipe 200, to the drawing pipe 300 consists of a first joining pipe 510 where the water supply pipe 200 is fitted and inserted on one side of the first joining pipe 510 in the longitudinal direction thereof and where a first inserting groove 512 is formed on the other end of the first joining pipe 510 in the longitudinal direction thereof, a first connecting pipe 520 where a first inserting bump 522 press-fitted into the first inserting groove 512 is formed to protrude on one end of the first connecting pipe 520 in the longitudinal direction thereof and where a first nipple 524 is provided on the other side of the first connecting pipe 520 in the longitudinal direction thereof, a second joining pipe 530 where a second inserting groove 532 is formed on one end of the second joining pipe 530 in the longitudinal direction thereof and where the drawing pipe 300 is fitted and inserted into the other side of the second joining pipe 530 in the longitudinal direction thereof, a second connecting pipe 540 where a second nipple 544 is provided on one side of the second connecting pipe 540 in the longitudinal direction thereof and where a second inserting bump 542 press-fitted into the second inserting groove 532 is formed to protrude on the other end of the second connecting pipe 540 in the longitudinal direction thereof, and a tube pipe 550 connecting the first nipple 524 and the second nipple 544.

The first joining pipe 510, the first connecting pipe 520, the second joining pipe 530, the second connecting pipe 540, and the tube pipe 550 are preferably manufactured with synthetic resins with a certain level of flexibility so as to block water from leaking from them when they combine to each other. In particular, the tube pipe 550 for connecting the first connecting pipe 520 and the second connecting pipe 540 spaced a certain distance apart from each other is preferably manufactured with synthetic resins containing a rubber substance so as to have a certain level of flexibility. Naturally, if the first joining pipe 510, the first connecting pipe 520, the second joining pipe 530, and the second connecting pipe 540 may be safely combined with each other without causing concern over a leak, any materials may be used.

Then, if the flow channel assembly 500 is not perfectly fixed in the body housing so that it is shaken, the combination of the water supply pipe 200 and the drawing pipe 300 does no remain safe. Preferably, the flow channel assembly 500 is fixedly installed in the body housing 100. As described above, in order for the flow channel assembly 500 to be fixed in the body housing 100, a first joining flange 516 is formed on the outer circumferential surface of the other side of the first joining pipe 510 in the longitudinal direction thereof, a first connecting flange 526 is formed on the outer circumferential surface of one side of the first connecting pipe 520 in the longitudinal direction thereof, a second joining flange 536 is formed on the outer circumferential surface of one side of the second joining pipe 530 in the longitudinal direction thereof, and a second connecting flange 546 is formed on the outer circumferential surface of the other side of the second connecting pipe 540 in the longitudinal direction thereof. Furthermore, a first press-fitting groove 130 and a second press-fitting groove 140 are formed at the point, out of the inside wall of the body housing 100, that corresponds to each flange. When the flow channel assembly 500 is mounted into the body housing 100, the first joining flange 516 and the first connecting flange 526 are press-fitted into the first press-fitting groove 130, and the second joining flange 536 and the second connecting flange 546 are press-fitted into the second press-fitting groove 140.

The first joining flange 516 and the first connecting flange 526 are forced to be pressed-fitted into the first press-fitting groove 130, and the second joining flange 536 and the second connecting flange 546 are also forced to be press-fitted into the second press-fitting groove 140. The flow channel assembly 500 may remain safely fixed in the body housing 100 as long as each flange is not damaged.

Furthermore, to block cleaning water from leaking between the joining pipes 510, 530 and the connecting pipes 520, 540, A first O-ring 514 may be provided on the surface where the first joining pipe 510 and the first connecting pipe 520 are touched to each other, and a second O-ring 534 may be provided on the surface where the second joining pipe 530 and the second connecting pipe 540 are touched to each other.

The first O-ring 514 is manufactured to be slightly thicker than the distance between the first joining pipe 510 and the first connecting pipe 520. When the first joining flange 516 and the first connecting flange 526 are press-fitted into the first press-fitting groove 130, the first joining pipe 510 and the first connecting pipe 520 are pressed and compressed the direction in which they become close to each other. The second O-ring 534 is also manufactured to be slightly thicker than the distance between the second joining pipe 530 and the second connecting pipe 540. When the second joining flange 536 and the second connecting flange 546 are press-fitted into the second press-fitting groove 140, the second joining pipe 530 and the second connecting pipe 540 are pressed and compressed in the direction where they become close to each other.

As described above, when the first O-ring 514 and the second O-ring 534 are compressed by means of the force with which the joining pipes 510, 530 and the connecting pipes 520, 540 are pressed-fitted into the press-fitting grooves 130, 140, the joining pipes 510, 530 and the connecting pipes 520, 540 may be completely combined so as to be sealed to each other.

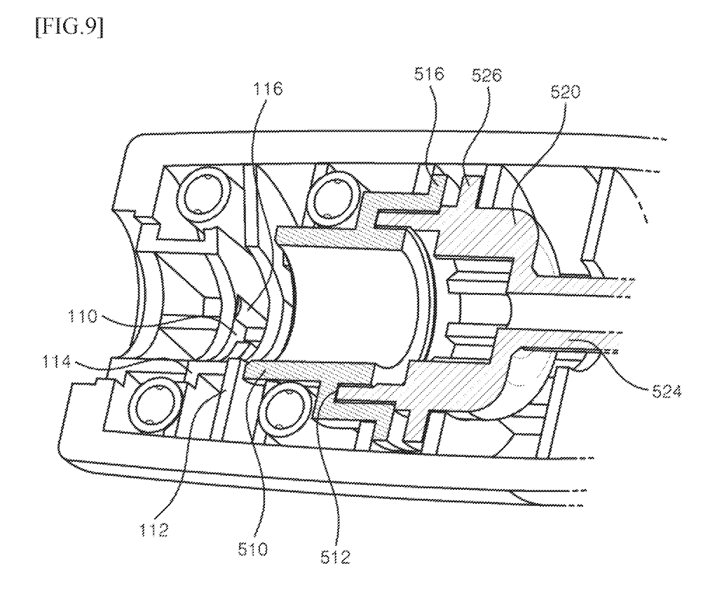

FIGS. 6 to 8 illustrate a consecutive process of combining a water supply pipe 200 with a body housing 100, and FIG. 9 is a cross-sectional perspective view illustrating the inner structure of a body housing 100.

When a water supply pipe 200 is inserted to be installed in a body housing 100, as illustrated in FIG. 6, the center line of the water supply pipe 200 is matched with the center line of the first joining pipe 510 and then, the water supply pipe 200 is pushed into the body housing 100 to a certain depth.

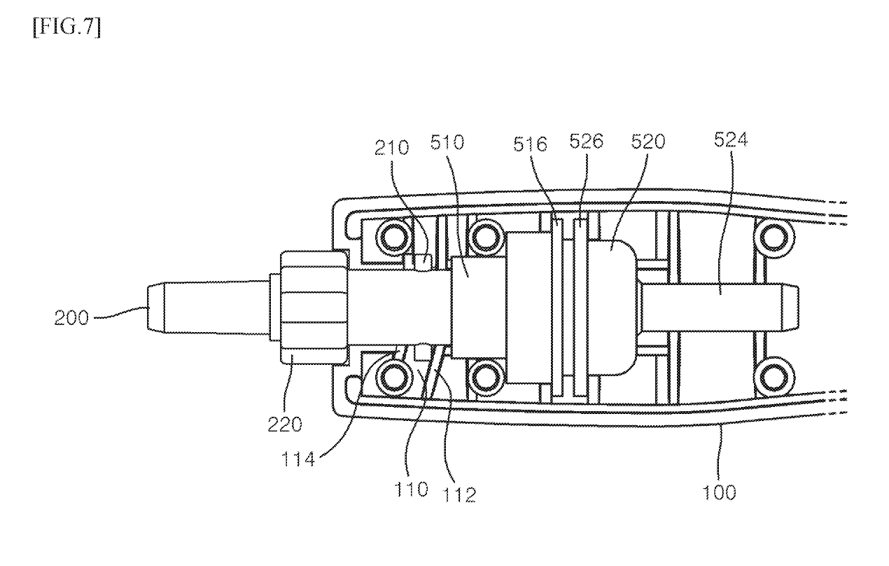

When the water supply pipe 200 is inserted as described above, as illustrated in FIG. 7, a first sliding bump 210 formed on the outer circumferential surface of the water supply pipe 200 is placed in a first sliding groove 110. In the process where the water supply pipe 200 is inserted, when the first sliding bump 210 is caught by the outside wall surface 112 of the first sliding groove 110, the first sliding bump 210 is not placed in the first sliding groove 110 as illustrated in FIG. 7. Preferably, the part that corresponds to the first sliding bump 210, out of the outside wall surface 112 of the first sliding groove 110 (more precisely, the part that corresponds to the moving path of the first sliding bump 210 when the water supply pipe 200 is inserted), is preferably formed low so as not to interfere with the first sliding bump 210.

Then, in order for the first sliding bump not to excessively move and to escape from the first sliding groove 110, the part that corresponds to the first sliding bump 210, out of the inside wall surface 114 of the first sliding groove 110 (more precisely, the part that corresponds to the moving path of the first sliding bump 210 when the water supply pipe 200 is inserted) is preferably formed high so as to catch the first sliding bump 210.

In the state illustrated FIG. 7, when the water supply pipe 200 rotates, the first sliding bump 210 is inserted deeper into the body housing 100 while sliding over the inclined surface of the first sliding groove 110. The end of the water supply pipe 200 is inserted deep enough into the first joining pipe 510.

Then, the water supply pipe 200 is inserted excessively, the first joining pipe 510 is damaged, or the first sliding bump 210 is fractured. According to a water toothbrush of the present invention, when the water supply pipe 200 is inserted to a preset depth, a protruding sill 116 for allowing the first sliding bump 210 to go over may be formed on the outside wall surface 112 of the first sliding groove.

As describe above, when the water supply pipe 200 is inserted to a preset depth and the first sliding bump 210 goes over the protruding sill 116, the user may feel a click such that the user rotates the water supply pipe 200 no more. As a result, the first joining pipe 510 may be blocked from being damaged, and the first sliding bump 210 may be blocked from being fractured. In the state where the first sliding bump 210 has gone over the protruding sill 116, the first sliding bump 210 adheres to the outside wall surface 112 of the first sliding groove 110. As a result, unless rotational force greater than or equal to a certain level is provided to the water supply pipe 200, the water supply pipe 200 does not rotate in the direction where the water supply pipe 200 falls off from the body housing 100.

Meanwhile, as the structure in which the drawing pipe 300 is combined with the body housing 100 is substantially the same as the structure in which the water supply pipe 200 is combined with the body housing 100 except for the direction, the process of combining the drawing pipe 300 with the body housing 100 will not be described.

While the present invention has been described in detail in connection with what is considered to be preferred embodiments, it is to be understood that the scope of the invention is not limited to the embodiments and should be translated by the attached claims. Additionally, it is to be understood that various changes and modifications may be made by those skilled in the art within the scope of the invention.

### DESCRIPTION OF SYMBOLS

100: Body housing 101: First mounting step
102: Second mounting step 110: First sliding groove
112: Outside wall surface 114: Inside wall surface
116: Protruding sill 120: Second sliding groove
130: First press-fitting groove 140: Second press-fitting groove
200: water supply pipe 210: First sliding bump
220: first mounting block 300: Drawing pipe
310: Second sliding bump 320: Second mounting block
400: Toothbrush body 410: Head
420: Emitting hole 430: Emitting flow channel
500: Flow channel assembly 510: First joining pipe
512: First inserting groove 514: First O-ring
516: First joining flange 520: First connecting pipe
522: First inserting bump 524: First nipple
526: First connecting flange 530: Second joining pipe
532: Second inserting groove 534: Second O-ring
536: Second joining flange 540: Second connecting pipe
542: Second inserting bump 544: Second nipple
546: Second connecting flange 550: Tube pipe

What is claimed:

1. A water toothbrush comprises:
a body housing 100 extended in one direction and having an inner hole formed along its longitudinal central axis;
a water supply pipe 200 whose one side in its longitudinal direction is combined with a water supply hose and whose other side in its longitudinal direction is inserted into one side of the body housing 100 in the longitudinal direction thereof and which has a first sliding bump 210 protruding on a part, out of its outer circumferential surface, inserted into the body housing 100;
a drawing pipe 300 whose one side in its longitudinal direction is inserted into the other side of the body housing 100 in the longitudinal direction thereof and which has a second sliding bump 310 protruding on a part, out of its outer circumferential surface, inserted into the body housing 100;
a toothbrush body 400, connecting to the other side of the drawing pipe 300 in the longitudinal direction thereof, which has a head 410 planted with bristles 412, has an emitting hole 420 formed on a surface, out of the head 410, where the bristles 412 are planted, and has an emitting flow channel 430 for linking the drawing pipe 300 and the emitting hole 420;
a flow channel assembly 500 fixedly installed in the inner hole of the body housing 100 and connecting the other side of the water supply pipe 200 in the longitudinal direction thereof with one side of the drawing pipe 300 in the longitudinal direction thereof, for guiding cleaning water supplied by the water supply pipe 200 into the drawing pipe 300; and
wherein the body housing has respectively a first sliding groove 110 and a second sliding groove 120 which are formed in both sides of the inner wall of the body housing 100 in the longitudinal direction thereof, and inclinedly arranged in a direction crossing to the circumferential direction of the body housing 100,
wherein the first sliding bump 210 and the second sliding bump 310 are configured to be mounted respectively into the first sliding groove 110 and the second sliding groove 120 when the other side of the water supply pipe 200 in the longitudinal direction thereof and one side of the drawing pipe 300 in the longitudinal direction thereof are inserted into the body housing 100, such that the water supply pipe 200 and the drawing pipe 300 may be combined with and detached from the flow channel assembly 500 according to the direction of their rotation.

2. The water toothbrush according to claim 1,
wherein a part, out of the outside wall surface 112 of the first sliding groove 110 and the outside wall surface 112 of the second sliding groove 120, that corresponds to the first sliding bump 210 or the second sliding bump 310 is formed low so as not to interfere with the first sliding bump 210 or the second sliding bump 310, when the water supply pipe 200 and the drawing pipe 300 are inserted,
wherein a part, out of the inside wall surface 114 of the first sliding groove 110 and the inside wall surface 114 of the second sliding groove 120, that corresponds to the first sliding bump 210 or the second sliding bump 310 is formed high so as to catch the first sliding bump 210 or the second sliding bump 310, when the water supply pipe 200 and the drawing pipe 300 are inserted, and
wherein a protruding sill 116 over which the first sliding bump 210 and the second sliding bump 310 go is formed on the outside wall surface 112 of the first sliding groove 110 and the outside wall surface 112 of the second sliding groove 120 when the water supply pipe 200 and the drawing pipe 300 are inserted into the body housing 100 to a preset depth.

3. The water toothbrush according to claim 1,
wherein the flow channel assembly 500 consists of a first joining pipe 510 where the water supply pipe 200 is fitted and inserted on one side of the first joining pipe 510 in the longitudinal direction thereof and where a first inserting groove 512 is formed on the other end of the first joining pipe 510 in the longitudinal direction thereof, a first connecting pipe 520 where a first inserting bump 522 press-fitted into the first inserting groove 512 is formed to protrude on one end of the first connecting pipe 520 in the longitudinal direction thereof and where a first nipple 524 is provided on the other side of the first connecting pipe 520 in the longitudinal direction thereof, a second joining pipe 530 where a second inserting groove 532 is formed on one end of the second joining pipe 530 in the longitudinal direction thereof and where the drawing pipe 300 is fitted and inserted into the other side of the second joining pipe 530 in the longitudinal direction thereof, a second connecting pipe 540 where a second nipple 544 is provided on one side of the second connecting pipe 540 in the longitudinal direction thereof and where a second inserting bump 542 press-fitted into the second inserting groove 532 is formed to protrude on the other end of the second connecting pipe 540 in the longitudinal direction thereof, and a tube pipe 550 connecting the first nipple 524 and the second nipple 544.

4. The water toothbrush according to claim 3,
wherein the first joining pipe 510 has a first joining flange 516 formed on the outer circumferential surface of the other side of the first joining pipe 510 in the longitudinal direction thereof, the first connecting pipe 520 has a first connecting flange 526 formed on the outer circumferential surface of one side of the first connecting pipe 520 in the longitudinal direction thereof, the second joining pipe 530 has a second joining flange 536 formed on the outer circumferential surface of one side of the second joining pipe 530 in the longitudinal direction thereof, and the second connecting pipe 540 has a second connecting flange 546 formed on the outer circumferential surface of the other side of the second connecting pipe 540 in length direction thereof, and
wherein the body housing 100 has a first press-fitting groove 130 which is formed on the inner wall of the body housing 100 and into which the first joining flange 516 and the first connecting flange 526 are pressed-fitted, and a second press-fitting groove 140 which is formed on the inner wall of the body housing 100 into which the second joining flange 536 and the second connecting flange 546 are press-fitted.

5. The water toothbrush according to claim 4,
wherein the first joining pipe 510 and the first connecting pipe 520 has a first O-ring 514 on a surface where the first joining pipe 510 and the first connecting pipe 520 are touched to each other, and the second joining pipe 530 and the second connecting pipe 540 has a second O-ring 534 on a surface where the second joining pipe 530 and the second connecting pipe 540 are touched to each other,
wherein the first joining pipe 510 and the first connecting pipe 520 are pressed in the direction where they become close to each other such that the first O-ring 514 is compressed, when the first joining flange 516 and the first connecting flange 526 are press-fitted into the first press-fitting groove 130, and
wherein the second joining pipe 530 and the second connecting pipe 540 are pressed in a direction where they become close to each other such that the second O-ring 534 is compressed, when the second joining flange 536 and the second connecting flange 546 are press-fitted into the second press-fitting groove 140.
